(19) United States
(12) Patent Application Publication
(10) Pub. No.: US 2026/0176492 A1
(43) Pub. Date: Jun. 25, 2026

(54) HIGH VOLUMETRIC LOADING OF PARTICLES IN UV CURABLE PHOTORESINS FOR LIGHT BASED ADDITIVE MANUFACTURING TECHNIQUES

(71) Applicant: The Charles Stark Draper Laboratory, Inc, Cambridge, MA (US)

(72) Inventor: Kasia Oleske, Cambridge, MA (US)

(73) Assignee: The Charles Stark Draper Laboratory, Inc, Cambridge, MA (US)

(21) Appl. No.: 19/427,809

(22) Filed: Dec. 19, 2025

Related U.S. Application Data
(60) Provisional application No. 63/737,283, filed on Dec. 20, 2024.

(51) Int. Cl. C09D 135/02; C08F 222/10

(52) U.S. Cl. CPC C09D 135/02; C08F 222/1025; C08F 2800/20; C08F 2810/20

(57) ABSTRACT

A photocurable resin system including a resin chemistry and a particle with UV-absorbing properties is described, where the particle may include a modified silane attached to a surface of the particle via a free oxide group. The modified silane may include a functional arm with a photoinitiator group attached thereto. The resin chemistry may include a diacrylate resin; a crosslinker; a reactive diluent; and a photoinitiator. The photocurable resin system may include a high volumetric loading of particles with sufficient curing to form a rigid polymer.

### RELATED APPLICATIONS

This application claims priority under 35 U.S.C. § 119 (e) to U.S. Provisional Patent Application No. 63/737,283, filed Dec. 20, 2024, and entitled “HIGH VOLUMETRIC LOADING OF PARTICLES IN UV CURABLE PHOTORESINS FOR LIGHT BASED ADDITIVE MANUFACTURING TECHNIQUES,” which is hereby incorporated by reference in its entirety.

### TECHNICAL FIELD

The present application describes particles (e.g., functionalized particles), photocurable resin systems, and methods of forming them and/or uses thereof. As one example, the present application describes a material system suitable for light based additive manufacturing or 3D printing techniques, and more specifically, a material system with high volumetric loading of particles for stereolithography and digital light processing additive manufacturing techniques.

### BACKGROUND

Photocurable resins utilized in stereolithography and digital light processing (SLA/DLP) printing techniques may utilize a resin including low viscosity monomers with acrylate or methacrylate functional groups and a photoinitiator to initiate the polymerization. When an ultraviolet (UV) light-source of sufficient power, for example provided via a laser, is exposed to the resin, the photoinitiator generates a free radical. The free radical is quickly consumed and propagated amongst the large amounts of acrylate and methacrylate functional groups, creating large molecular weight compounds. When the polymers reach a sufficiently high enough molecular weight (e.g., through the incorporation of many chains through convergence of a crosslinking functional group), the resin hardens to the point of behaving as a solid.

The UV-source laser typically has a frequency of 350-455 nm and power of approximately 100-300 mW. The confinement of such power on a localized region selectively crosslinks the resin in three dimensions, allowing for a layer-by-layer process to produce a 3D structure.

Particles may be introduced into the resin in order to produce secondary effects or properties. When introduced into acrylate or methacrylate resins, the addition of conventional particles into the resin interferes with the free radical generation. These conventional particles block the photoinitiator in the dispersed composite. Furthermore, simply increasing the concentration of photoinitiator in the resin does not increase crosslinking since the conventional particles subsequently interfere with UV transmission.

Besides the obstacles of conventional particles such as conventional dark particles with UV-photoinitiation, the incorporation of conventional dark particles may also adversely affect the mechanical strength of the end composite. When adding conventional dark particles to a photocurable resin, the dark particles typically settle out of solution due to the heterogeneous nature. This lack of homogenous distribution prevents uniform thermo-mechanical, electrical and radiofrequency properties of the end composite. Thus, SLA/DLP resins have been restricted to minimal volumetric loading of UV-absorbing particles, and are typically limited to 20% by volume loading or less to minimize the aforementioned obstacles associated with conventional particle inclusion.

### SUMMARY

The subject matter of the present disclosure involves, in some cases, interrelated products, alternative solutions to a particular problem, and/or a plurality of different uses of one or more systems and/or articles.

According to at least one embodiment, a photocurable resin with high volumetric loading of UV absorbing particles is provided.

Certain aspects are related to particles. In some embodiments, the particle comprises a surface with a free oxide surface group thereon; and a modified silane attached to the free oxide surface group; wherein the modified silane comprises a functional arm attached to a photoinitiator group.

In certain embodiments, the particle comprises a dark ceramic particle. In some embodiments, the particle comprises iron oxide. In accordance with certain embodiments, the photoinitiator is covalently bonded to the functional arm. According to some embodiments, the functional arm comprises an isocyanate, azide, alkyne, amine, methacrylate, acrylate, and/or epoxide. According to certain embodiments, the modified silane comprises 3-isocyanatopropyl)-triethoxysilane (IPTS), APTES (aminopropyltriethoxysilane), (3-mercaptopropyl)trimethoxysilane (MPTMS), glycidoxypropyltrimethoxysilane (GPTMS), vinyltrimethoxylsilane, 3-acryloxypropyl)trimethoxysilane, and/or acryloxymethyltrimethoxysilane. In some embodiments, the photoinitiator group comprises 2-hydroxy-2-methylpropiophenone (HMPP), 1-hydroxycyclohexyl phenyl ketone (HCPK)), benzophenone, 4-methylbenzophenone, 4-chlorobenzophenone, 4,4′-bis(diethylamino)), 2-isopropylthioxanthone (ITX)), 2-ethylanthraquinone (EAQ)), diphenyl(2,4,6-trimethylbenzoyl) phosphine oxide (TPO), 2-methyl-4′-(methylthio)-2-morpholinopropiophenone (TPO-L)), and/or benzoin methyl ether (BME).

Certain aspects relate to a photocurable resin system. In some embodiments, the photocurable resin system comprises a resin chemistry comprising: a diacrylate resin, a crosslinker, a reactive diluent, and a photoinitiator; and a particle (e.g., any particle disclosed herein, such as a particle comprising a surface with a free oxide surface group thereon; and a modified silane attached to the free oxide surface group; wherein the modified silane comprises a functional arm attached to a photoinitiator group) dispersed in the resin chemistry.

In some embodiments, the resin chemistry further comprises a thermal initiator compound. In certain embodiments, the resin chemistry comprises greater than or equal to 0.1 wt % and less than or equal to 10 wt % of the thermal initiator compound. According to some embodiments, the diacrylate resin comprises a bisphenol diacrylate resin. According to certain embodiments, the resin chemistry comprises: greater than or equal to 20 wt. % and less than or equal to 70 wt. % of the diacrylate resin; greater than or equal to 10 wt. % and less than or equal to 50 wt. % of the crosslinker; greater than or equal to 20 wt. % and less than or equal to 60 wt. % of the reactive diluent; and greater than or equal to 4 wt. % and less than or equal to 20 wt. % of the photoinitiator.

Certain aspects relate to methods of forming a UV-absorbing particle. In some embodiments, a method of forming a UV-absorbing particle comprises forming a modified silane with an attached photoinitiator group; and attaching the modified silane onto a surface of a particle. In certain embodiments, the method comprises mixing a slurry of the modified silane and particles to coat the particles with the modified silane and form functionalized particles. According to some embodiments, the method further comprises washing the functionalized particles; and drying the functionalized particles.

Certain embodiments relate to methods of forming a photocurable resin system. In some embodiments, a method of forming a photocurable resin system comprises forming a modified silane with an attached photoinitiator group; attaching the modified silane onto a surface of a particle to form a functionalized particle; and adding the functionalized particle to a resin chemistry. In certain embodiments, the resin chemistry comprises: a diacrylate resin; a crosslinker; a reactive diluent; and a photoinitiator. According to some embodiments, the resin chemistry comprises: greater than or equal to 20 wt. % and less than or equal to 70 wt. % of the diacrylate resin; greater than or equal to 10 wt. % and less than or equal to 50 wt. % of the crosslinker; greater than or equal to 20 wt. % and less than or equal to 60 wt. % of the reactive diluent; and greater than or equal to 4 wt. % and less than or equal to 20 wt. % of the photoinitiator.

In accordance with some embodiments, the particle comprises a dark ceramic particle. According to certain embodiments, the photoinitiator group is covalently attached to a functional arm of the modified silane. In accordance with certain embodiments, the modified silane comprises 3-isocyanatopropyl)-triethoxysilane (IPTS), APTES (aminopropyltriethoxysilane), (3-mercaptopropyl)trimethoxysilane (MPTMS), glycidoxypropyltrimethoxysilane (GPTMS), vinyltrimethoxylsilane, 3-acryloxypropyl)trimethoxysilane, and/or acryloxymethyltrimethoxysilane. In accordance with some embodiments, the photoinitiator group comprises 2-hydroxy-2-methylpropiophenone (HMPP), 1-hydroxycyclohexyl phenyl ketone (HCPK)), benzophenone, 4-methylbenzophenone, 4-chlorobenzophenone, 4,4′-bis(diethylamino)), 2-isopropylthioxanthone (ITX)), 2-ethylanthraquinone (EAQ)), diphenyl(2,4,6-trimethylbenzoyl) phosphine oxide (TPO), 2-methyl-4′-(methylthio)-2-morpholinopropiophenone (TPO-L)), and/or benzoin methyl ether (BME).

According to at least one embodiment, a particle comprises a surface with a free oxide surface group thereon, and a modified silane attached to the free oxide surface group. The modified silane includes a functional arm with a photoinitiator group attached thereto, in accordance with certain embodiments.

According to one or more embodiments, a particle comprises a dark ceramic particle. In at least one embodiment, the functional arm may be an isocyanate arm. In one or more embodiments, the modified silane may be (3-isocyanatopropyl)-triethoxysilane (IPTS), and the photoinitiator group may be 2-hydroxy-2-methylpropiophenone (HMPP). In at least one embodiment, the particle may be iron oxide. In one or more embodiments, the photoinitiator may be covalently bonded to the functional arm.

According to one or more embodiments, a photocurable resin system includes a resin chemistry and a UV-absorbing particle dispersed in the resin. The resin chemistry includes a diacrylate resin; a crosslinker; a reactive diluent; and a photoinitiator, in certain embodiments. The particle comprises a particle comprising a free oxide surface group thereon, and a modified silane attached to the free oxide surface group, with the modified silane including a functional arm with a photoinitiator group attached thereto, in accordance with some embodiments.

According to at least one embodiment, the resin chemistry may further include one or more thermal initiator compounds. In at least one further embodiment, the thermal initiator compound may be introduced at 0.5 wt. %. In one or more embodiments, the diacrylate resin may be a bisphenol diacrylate resin. In at least one embodiment, the resin chemistry has a formulation of: 40 wt. % bisphenol A glycerolate dimethacrylate as the diacrylate resin; 15 wt. % trimethylolpropane triacrylate as the crosslinker; 40 wt. % of 1,6 hexanediodiacrylate as the reactive diluent; and 5 wt. % of 2-hydroxy-2-methylpropiophenone as the photoinitiator.

According to one or more embodiments, a method of forming a UV-absorbing particle is provided. The method includes forming a modified silane with an attached photoinitiator group; and attaching the modified silane onto a surface of a particle, in some embodiments.

In at least one embodiment, the method may further include mixing a slurry of the modified silane and particles to coat the particles with the modified silane and form functionalized particles. In one or more embodiments, the method may further include washing the functionalized particles; and drying the functionalized particles.

According to one or more embodiments, a method of forming a photocurable resin system is provided. The method includes forming a modified silane with an attached photoinitiator group, attaching the modified silane onto a surface of a particle to form a functionalized particle, and adding the functionalized particle to a resin chemistry, in certain embodiments.

According to at least one embodiment, the resin chemistry may include a diacrylate resin; a crosslinker; a reactive diluent; and a photoinitiator. In one or more embodiments, the resin chemistry may have a formulation of: 40 wt. % bisphenol A glycerolate dimethacrylate as the diacrylate resin; 15 wt. % Trimethylolpropane triacrylate as the crosslinker; 40 wt. % of 1,6 hexanediodiacrylate as the reactive diluent; and 5 wt. % of 2-hydroxy-2-methylpropiophenone as the photoinitiator. In one or more embodiments, the photoinitiator group may be covalently attached to a functional arm of the modified silane. In at least one embodiment, the particle may be a dark ceramic. In one or more embodiments, the modified silane may be (3-isocyanatopropyl)-triethoxysilane (IPTS), and the photoinitiator group may be 2-hydroxy-2-methylpropiophenone (HMPP).

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a flow chart depicting a method of forming a photocurable resin system, according to at least one embodiment;

FIG. 2 is a schematic diagram of forming a modified silane with a photoinitiator group attached, according to some embodiments;

FIG. 3 is an NMR spectrogram of a modified silane prior to reacting with dark particles;

FIG. 4 is a schematic diagram of attaching the modified silane to a surface of a dark particle, according to some embodiments;

FIG. 5 is a schematic diagram of a dark particle modified silanes attached thereto, according to one or more embodiments;

FIG. 6 is a table of resin chemistries and accompanying chemical structures of components;

FIG. 7 is a graph showing viscosity vs. shear rate of the resin chemistry with and without functionalized dark particles;

FIG. 8 shows images of vessels with resin chemistries with regular dark particles and functionalized dark particles;

FIG. 9 is a schematic diagram of UV-curing a resin system with a laser, according to some embodiments;

FIG. 10 shows images of a resin chemistry without dark particles before UV treatment, after UV treatment, and after thermal treatment;

FIG. 11 shows images of a resin chemistry without and with thermal initiator compounds after exposure to heat;

FIG. 12 shows images of a resin chemistry with unfunctionalized dark particles before UV treatment, after UV treatment, and after thermal treatment;

FIG. 13 shows images of a resin chemistry with functionalized dark particles according to at least one example before UV treatment, after UV treatment, after thermal treatment, upon removal from a glass slide, and standing on its side;

FIG. 14 are graphs comparing cross-linking for resin chemistries.

### DETAILED DESCRIPTION

According to one or more embodiments, a photocurable resin formulation with high volumetric loading of UV absorbing particles is provided. While dark particles may be referenced herein in various embodiments, the modifications to the particles disclosed herein may be applied to other particles (e.g., any particle with an —OH surface group), and discussion of “UV-absorbing dark particles” hereinafter is not intended to be limiting.

Non-limiting examples of UV absorbing dark particles include ceramics, such as iron oxide. In some embodiments, the particle (e.g., UV absorbing dark particles, such as iron oxide particles) have a size (e.g., average diameter) of greater than or equal to 0.01 microns, greater than or equal to 0.02 microns, greater than or equal to 0.03 microns, greater than or equal to 0.05 microns, greater than or equal to 1 micron, greater than or equal to 2 microns, greater than or equal to 3 microns, greater than or equal to 5 microns, greater than or equal to 7 microns, greater than or equal to 10 microns, greater than or equal to 15 microns, greater than or equal to 20 microns, or greater than or equal to 30 microns. In certain embodiments, the particle (e.g., UV absorbing dark particles, such as iron oxide particles) have a size (e.g., average diameter) of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 5 microns, or less than or equal to 1 microns. Combinations of these ranges are also possible (e.g., greater than or equal to 0.01 microns and less than or equal to 50 microns, or greater than or equal to 0.03 microns and less than or equal to 30 microns).

In some embodiments, the volumetric loading of the resin is at least 30 vol %, at least 35 vol %, at least 40 vol %, at least 45 vol %, at least 50 vol %, or at least 55 vol % of particles (e.g., UV absorbing dark particles, such as iron oxide particles). In accordance with certain embodiments, the volumetric loading of the resin is less than or equal to 75 vol %, less than or equal to 70 vol %, less than or equal to 65 vol %, or less than or equal to 60 vol % of UV absorbing dark particles. Combinations of these ranges are also possible (e.g., at least 30 vol % and less than or equal to 75 vol %, or at least 40 vol % and less than or equal to 60 vol %). For example, the volumetric loading of the presently described resin may be, in some embodiments, at least 30 vol %, in other embodiments, 40-60 vol %, and in yet other embodiments up to 75 vol % of UV absorbing dark particles (hereinafter interchangeably ‘dark particles’) such as, for example, iron oxide, with sizes (e.g., average diameters) of 0.01-50 μm in some embodiments, and 0.03-30 μm in other embodiments.

The dark particles are loaded into the photocurable resin formulation and used for stereolithography and digital light processing (SLA/DLP) printing techniques, in certain embodiments. Thus, according to at least one embodiment, the fabrication methods of the composites from the photocurable resin described herein, and the suitability of this resin for SLA/DLP additive manufacturing techniques are provided.

According to at least one embodiment, the photocurable resin formulation includes silane chemistries introduced with varying functional arms (e.g., to improve homogeneous distribution and photocuring during the printing process). In at least one embodiment, the resin chemistry includes one or more thermal initiator compounds (e.g., to enable post-print free radicalization to promote complete curing post-printing, thus producing a rigid composite structure upon curing). Furthermore, in at least one embodiment, the adjusted resin formulation with optimal viscosity regime to handle high volumetric loading of fillers while still suitable for crosslinking in printing process in the final composite structure. As such, the material system of the resin formulation, the chemistry of the UV-absorbing particles, as well as the methods of forming each and their combination, are provided according to various embodiments.

More specifically, according to one or more embodiments, the UV-absorbing particles, such as dark particles, loaded into the photocurable resin formulation are modified via attachment of functionalized silanes to the particle surfaces. In some embodiments, the silanes have functional arms and are able to directly attach to the surfaces of the dark particles. According to certain embodiments, the silanes also include a photoinitiator. In accordance with some embodiments, the attachment of the silanes is all around the surface of the dark particles, generating a spherical shell of functional arms with photoinitiator around the surface of each dark particle. In certain embodiments, the functionalization of the surface with the silanes promotes homogenous distribution of the dark particles within the photocurable resin. Furthermore, the photoinitiator on the functional arms of the silanes mitigates the blocking of photoinitiation, as the photoinitiator is exposed first before the particles absorb the laser UV light, in some embodiments.

According to at least one embodiment, a particle, such as a dark particle, with UV absorbing properties is provided. As previously noted, the particle may be any suitable UV-absorbing particle, and discussion of dark particles is not intended to be limiting, and is thus referenced interchangeably hereinafter. The particles include a modified silane with an attached photoinitiator group, in some cases. In certain embodiments, the particle may be any suitable UV-absorbing material that provides a UV absorptive effect or property to the resin. In some embodiments, the particle comprises a surface comprising a functional group to which augmenting moieties may be attached. The particle may be, in some embodiments, a dark particle, such as iron oxide, but in other embodiments may be any other suitable dark particle, such as, but not limited to, other ceramics or materials with or without oxide surface groups, and reference to or discussion of iron oxide or ceramics with oxide groups is not intended to be limiting. In some cases, the oxide surface groups allow for direct attachment of the modified silane to the oxide on the particle surface. In examples where the particles do not have a free oxide groups on the surface (e.g., barium strontium titanate, as a non-limiting example), the particles may be washed in a strong base in order to add oxide groups to the surface. The strong base may be any suitable strong base, such as, but not limited to, potassium hydroxide. Thus, in at least one embodiment, multiple silane groups may be attached to the surface of the particle. In at least one embodiment, the particles have an average size (e.g., average diameter) of 0.01-50 μm in some embodiments, and 0.03-30 μm in other embodiments.

In some embodiments, the photoinitiator groups are covalently bonded to the functional arms of the silanes which are attached over the surface of the particle. In at least one embodiment, the silane includes a functional arm. The functional arm of the silane may be any suitable chemistry for attachment of a photoinitiator group, including, but not limited to, an isocyanate, an azide, an alkyne, and/or an epoxide. In some embodiments, the silane (e.g., prior to modification) comprises (3-isocyanatopropyl)-triethoxysilane (IPTS), an amino functional silane, a thiol functional silane, an epoxy functional silane, a vinyl functional silane, a carboxylic acid silane, an ester silane, APTES (aminopropyltriethoxysilane) (e.g., for amines), (3-mercaptopropyl)trimethoxysilane (MPTMS) (e.g., for thiols), glycidoxypropyltrimethoxysilane (GPTMS) (e.g., for epoxies), vinyltrimethoxylsilane, a silane with one or more ester groups, a silane with one or more anhydride groups, 3-acryloxypropyl)trimethoxysilane, and/or acryloxymethyltrimethoxysilane. In at least one example, the silane may be (e.g., prior to modification) (3-isocyanatopropyl)-triethoxysilane (IPTS).

In certain embodiments, the silane is reacted with a catalyst and a photoinitiator in order to form the modified silane. In the example where the silane is IPTS, the photoinitiator may be 2-hydroxy-2-methylpropiophenone and the catalyst may be any suitable catalyst, including, but not limited to, dibutyltin dilaurate. In other examples, where the silane is IPTS, the photoinitiator may be any suitable component that photo initiates and releases heat, including, but not limited to, α-Hydroxy Ketones, α-Aminoketones, Acylphosphine Oxides, Benzoin Ethers, Aromatic Ketones, Thioxanthones, Anthraquinones, Onium Salts, Acridinium Salts, and Xanthene Dyes. The modified silane thus includes a covalent bonded photoinitiator on the functional arm of the silane, formed by reaction between the isocyanate arm of the silane and the alcohol group on the photoinitiator, in some embodiments. While silanes with isocyanate arms are described herein, this is not intended to be limiting, and silanes with varying and combinations of functional groups such as amines, methacrylate, acrylate, and epoxide groups are also suitable to initiate successful dispersion of dark particles into the resin chemistry.

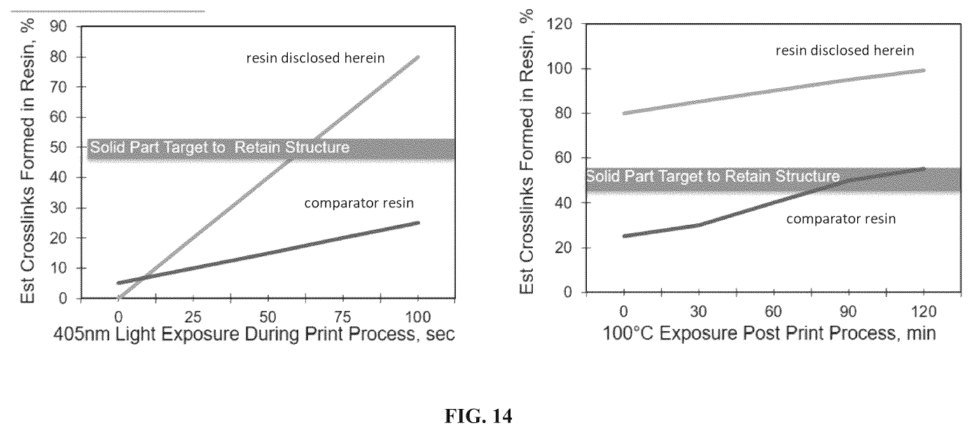

According to at least one embodiment, a photocurable resin system with a high volumetric loading (e.g., at least 30% volumetric loading in certain embodiments, 30%-75% volumetric loading in some embodiments, and 40-60% volumetric loading in other embodiments) of UV-absorbing particles is provided. In certain embodiments, the photocurable resin system includes UV-absorbing particles as described above, which include a modified silane with an attached photoinitiator group on the functional arm of the silane. In some cases, the resin chemistry of the photocurable resin system to which the UV-absorbing particles are added may be any suitable photocurable resin, including but not limited to, a formulation of components that would react upon UV and thermal exposure to produce a solid crosslinked polymer. FIG. 14 shows an example comparison of the capacity of photoinitiator modified particles, in accordance with some embodiments, to enable UV light and thermal exposure to cure low band gap energy particle resins with higher loadings as compared with conventional resins. In at least one embodiment, the base resin formulation includes a diacrylate, acrylate, or methacrylate monomer resin, a crosslinker, a reactive diluent, and a photoinitiator. In some embodiments, the monomer resin provides rigidity and strength to the resultant polymer, and the crosslinker increases the speed of polymerization. In some cases, the reactive diluents reduce resin viscosity and allow for flexibility in formulation. In at least one embodiment, the monomer resin is a diacrylate resin. In at least one further embodiment, the diacrylate resin may be a bisphenol diacrylate resin. In one or more embodiments, base resin components can be interchanged with various acrylate and methacrylate monomers, and may generally include two or more acryl or methacryl functionalities, and discussion of a diacrylate resin is not intended to be limiting. In one non-limiting example, the base resin formulation is composed of bisphenol A glycerolate dimethacrylate as the diacrylate resin, trimethylolpropane triacrylate as the crosslinker, 1,6 hexanediol diacrylate as the reactive diluent, and 2-hydroxy-2-methylpropiophenone (HMPP) as the photoinitiator. While the HMPP is provided as an example of the photoinitiator, which is also provided on the UV-absorbing particles, other photoinitiators for the dark particle and/or the resin formulation are contemplated as previously discussed, and including similar photoinitiators is not intended to be limiting. In some embodiments, the photoinitiator in the base resin formulation is the same as the photoinitiator on the UV-absorbing particles. In certain embodiments, the photoinitiator in the base resin formulation is different from the photoinitiator on the UV-absorbing particles.

According to certain embodiments, the base resin formulation comprises a diacrylate, acrylate, or methacrylate monomer resin. For example, in some embodiments, the base resin formulation comprises a diacrylate resin. In certain cases, the diacrylate resin comprises a functional polymer sensitive to the photoinitator. Non-limiting examples of the diacrylate, acrylate, or methacrylate monomer resin include bisphenol A glycerolate dimethacrylate, poly(ethylene glycol) diacrylate, tri (propylene glycol) diacrylate, bisphenol a ethoxylate diacrylate, 1,6-hexanediol dimethacrylate, ethylene glycol dimethacrylate, gelatin methacryloyl, vanillin diacrylate, vanillin dimethacrylate, epoxy acrylates, bisphenol A diglycidyl ether diacrylate, propylene glycol diacrylate, tri (propylene glycol) diacrylate, and diethylene glycol dimethacrylate. According to some embodiments, the diacrylate resin comprises bisphenol A glycerolate dimethacrylate.

In certain embodiments, the base resin formulation comprises greater than or equal to 20 wt %, greater than or equal to 22 wt %, greater than or equal to 25 wt %, greater than or equal to 27 wt %, greater than or equal to 30 wt %, greater than or equal to 32 wt %, greater than or equal to 35 wt %, greater than or equal to 37 wt %, greater than or equal to 39 wt %, greater than or equal to 40 wt %, greater than or equal to 42 wt %, or greater than or equal to 45 wt % of a diacrylate resin (or of an acrylate or methacrylate monomer resin). According to certain embodiments, the base resin formulation comprises less than or equal to 70 wt %, less than or equal to 68 wt %, less than or equal to 65 wt %, less than or equal to 63 wt %, less than or equal to 60 wt %, less than or equal to 58 wt %, less than or equal to 55 wt %, less than or equal to 53 wt %, less than or equal to 50 wt %, less than or equal to 48 wt %, less than or equal to 45 wt %, less than or equal to 43 wt %, less than or equal to 41 wt %, less than or equal to 40 wt %, less than or equal to 38 wt %, or less than or equal to 35 wt % of a diacrylate resin (or of an acrylate or methacrylate monomer resin). Combinations of these ranges are also possible (e.g., greater than or equal to 20 wt % and less than or equal to 70 wt %, greater than or equal to 32 wt % and less than or equal to 48 wt %, greater than or equal to 35 wt % and less than or equal to 45 wt %, or greater than or equal to 39 wt % and less than or equal to 41 wt %).

In some embodiments, the base resin formulation comprises a crosslinker. In some cases, the crosslinker comprises a miscible (e.g., in the base resin formulation) multi-functional molecule that can interlink multiple polymer chains. Non-limiting examples of crosslinkers include epoxies (e.g., DGEBA), diisocyanates, photo-activated agents (e.g., bis-diazirine), molecules that possess two or more functional groups (e.g. hydroxyl, epoxy, and/or vinyl) that can react with complementary groups on different polymer chains, p-divinylbenzene, catechols, glutaraldehyde/glyoxal, trimethylolpropane triacrylate (TMPTA), pentaerythritol triacrylate, 1,1,1-trimethylolpropane triacrylate (TriMPTA), 1,1,1-trimethylolpropane trimethacrylate, dipentaerythritol pentaacrylate (mixture of tetra-, penta-, hexaacrylate), pentaerythritol tetraacrylate, and/or pentaerythritol triacrylate. According to some embodiments, the crosslinker comprises trimethylolpropane triacrylate.

In certain embodiments, the base resin formulation comprises greater than or equal to 10 wt %, greater than or equal to 12 wt %, greater than or equal to 13 wt %, greater than or equal to 14 wt %, greater than or equal to 15 wt %, of greater than or equal to 16 wt %, greater than or equal to 18 wt %, greater than or equal to 20 wt %, greater than or equal to 25 wt %, greater than or equal to 30 wt %, greater than or equal to 35 wt %, or greater than or equal to 40 wt % of a crosslinker. According to certain embodiments, the base resin formulation comprises less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 18 wt %, less than or equal to 17 wt %, less than or equal to 16 wt %, less than or equal to 15 wt %, or less than or equal to 14 wt % of a crosslinker. Combinations of these ranges are also possible (e.g., greater than or equal to 10 wt % and less than or equal to 50 wt %, greater than or equal to 12 wt % and less than or equal to 18 wt % or greater than or equal to 14 wt % and less than or equal to 16 wt %).

In some embodiments, the base resin formulation comprises a reactive diluent. In some cases, the reactive diluent comprises a miscible (e.g., in the base resin formulation) difunctional molecule. For example, in certain instances, the reactive diluent comprises a miscible (e.g., in the base resin formulation) molecule comprising a diacrylate functionality and/or an acrylamide functionality. Non-limiting examples of reactive diluents include 1,6 hexanediol diacrylate, neopentyl glycol digylcidyl ether, 1,4-butanediol diglycidyl ether, 1,6-hexanediol diglycidyl ether, hexanediol diacrylate, resorcinol diglycidyl ether, tripropylene glycol diacrylate, tricyclodecane dimethanol diacrylate, dipropylene glycol diacrylate, PEG diacrylate, polypropylene glycol diacrylate, and poly caprolactone. According to some embodiments, the reactive diluent comprises 1,6 hexanediol diacrylate.

In certain embodiments, the base resin formulation comprises greater than or equal to 20 wt %, greater than or equal to 22 wt %, greater than or equal to 25 wt %, greater than or equal to 27 wt %, greater than or equal to 30 wt %, greater than or equal to 32 wt %, greater than or equal to 35 wt %, greater than or equal to 37 wt %, greater than or equal to 39 wt %, greater than or equal to 40 wt %, greater than or equal to 42 wt %, or greater than or equal to 45 wt % of reactive diluent. According to certain embodiments, the base resin formulation comprises less than or equal to 60 wt %, less than or equal to 58 wt %, less than or equal to 55 wt %, less than or equal to 53 wt %, less than or equal to 50 wt %, less than or equal to 48 wt %, less than or equal to 45 wt %, less than or equal to 43 wt %, less than or equal to 41 wt %, less than or equal to 40 wt %, less than or equal to 38 wt %, or less than or equal to 35 wt % of reactive diluent. Combinations of these ranges are also possible (e.g., greater than or equal to 20 wt % and less than or equal to 60 wt %, greater than or equal to 32 wt % and less than or equal to 48 wt %, greater than or equal to 35 wt % and less than or equal to 45 wt %, or greater than or equal to 39 wt % and less than or equal to 41 wt %).

In some embodiments, the base resin formulation comprises a photoinitiator. In some cases, the photoinitiator is a free radical UV-initiator. In certain embodiments, the photoinitiator comprises an α-hydroxy ketone, an α-aminoketone, an acylphosphine oxide, a benzoin ether, an aromatic ketone, a thioxanthone, an anthraquinone, an onium salt, an acridinium salt, and/or a xanthene dye. In some embodiments, the photoinitiator comprises a free radical UV initiator Type I (bond cleavage) (e.g., an alpha-hydroxy ketone, such as 2-hydroxy-2-methylpropiophenone (HMPP) and/or 1-hydroxycyclohexyl phenyl ketone (HCPK)), a free radical UV initiator Type II (hydrogen abstraction) (e.g., a benzophenone (e.g., benzophenone, 4-methylbenzophenone, 4-chlorobenzophenone, and/or 4,4′-bis(diethylamino)), a thioxanthone (e.g., 2-isopropylthioxanthone (ITX)), and/or 2-ethylanthraquinone (EAQ)), a phosphine oxide (e.g., diphenyl(2,4,6-trimethylbenzoyl) phosphine oxide (TPO) and/or 2-methyl-4′-(methylthio)-2-morpholinopropiophenone (TPO-L)), a benzoin ether (e.g., benzoin methyl ether (BME)), a HABI derivative (e.g., o-Cl-HABI, and/or O-ethoxy HABI), and/or a blend thereof (e.g., a blend of TPO and TPO-L). According to some embodiments, the photoinitiator comprises 2-hydroxy-2-methylpropiophenone.

In certain embodiments, the base resin formulation comprises greater than or equal to 4 wt %, greater than or equal to 4.5 wt %, greater than or equal to 5 wt %, greater than or equal to 5.5 wt %, greater than or equal to 6 wt %, greater than or equal to 8 wt %, greater than or equal to 10 wt %, greater than or equal to 12 wt %, greater than or equal to 15 wt %, or greater than or equal to 17 wt % of a photoinitiator. According to certain embodiments, the base resin formulation comprises less than or equal to 20 wt %, less than or equal to 18 wt %, less than or equal to 15 wt %, less than or equal to 13 wt %, less than or equal to 10 wt %, less than or equal to 9 wt %, less than or equal to 8 wt %, less than or equal to 7 wt %, less than or equal to 6 wt %, less than or equal to 5.5 wt %, less than or equal to 5 wt %, or less than or equal to 4.5 wt % of a photoinitiator. Combinations of these ranges are also possible (e.g., greater than or equal to 4 wt % and less than or equal to 20 wt %, greater than or equal to 4 wt % and less than or equal to 6 wt % or greater than or equal to 4.5 wt % and less than or equal to 5.5 wt %).

According to some embodiments, the base resin formulation comprises greater than or equal to 20 wt. % and less than or equal to 70 wt. % of diacrylate resin; greater than or equal to 10 wt. % and less than or equal to 50 wt. % of a crosslinker; greater than or equal to 20 wt. % and less than or equal to 60 wt. % of reactive diluent; and greater than or equal to 4 wt. % and less than or equal to 20 wt. % of a photoinitiator. In one or more embodiments, the base resin formulation comprises 32-48 wt % of diacrylate resin, 12-18 wt % of a crosslinker, 32-48 wt % reactive diluent, and 4-6 wt % of a photoinitiator. In at least one embodiment, the base resin formulation comprises 40 wt % of diacrylate resin, 15 wt % of a crosslinker, 40 wt % reactive diluent, and 5 wt % of a photoinitiator. In a non-limiting example, a resin formulation according to embodiments of the present disclosure comprises 40 wt. % bisphenol A glycerolate dimethacrylate, 15 wt. % trimethylolpropane triacrylate, 40 wt. % of 1,6 hexanediol diacrylate and 5 wt % of 2-hydroxy-2-methylpropiophenone.

In one or more embodiments, the base resin formulation is combined with a thermal initiator compound. Non-limiting examples of thermal initiator compounds include, but are not limited to, molecules with functionalities of peroxides, azocompounds, dioxetanes, alkoxyamines, acyl peroxides, persulfates, and/or ditihiocarbamates. In some embodiments, the base resin formulation comprises greater than or equal to 0.1 wt %, greater than or equal to 0.2 wt %, greater than or equal to 0.3 wt %, greater than or equal to 0.4 wt %, greater than or equal to 0.5 wt %, greater than or equal to 0.6 wt %, greater than or equal to 0.8 wt %, greater than or equal to 1 wt %, greater than or equal to 2 wt %, greater than or equal to 3 wt %, greater than or equal to 4 wt %, greater than or equal to 5 wt %, greater than or equal to 6 wt %, or greater than or equal to 7 wt % of the thermal initiator compound. In certain embodiments, the base resin formulation comprises less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, less than or equal to 2 wt %, less than or equal to 1 wt %, less than or equal to 0.8 wt %, or less than or equal to 0.6 wt % of the thermal initiator compound. Combinations of these ranges are also possible (e.g., greater than or equal to 0.1 wt % and less than or equal to 10 wt %, greater than or equal to 0.1 wt % and less than or equal to 1 wt %, or greater than or equal to 0.4 wt % and less than or equal to 0.6 wt %).

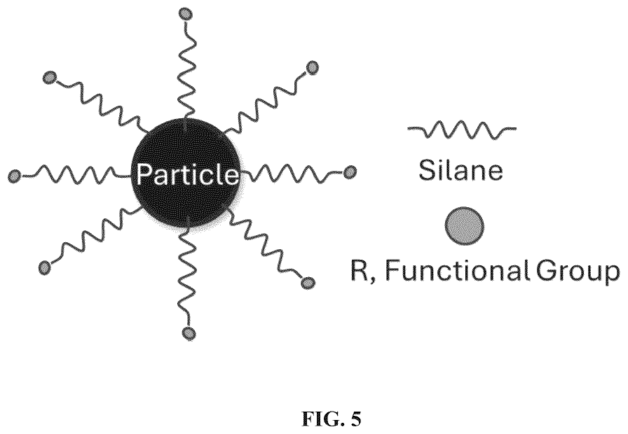

Thermal initiator compounds use heat to generate free radicals which may further propagate reactions in the resin. In some embodiments, the resin chemistry is exposed to heat via laser exposure, but heat may also be applied in post print UV-thermal chambers. In one example, the resin chemistry was fabricated by adding each component to a glass scintillation vial and repeated mixing segments of 2000 RPM for 3 minutes on a speed-mixer. Example formulations that were utilized are noted in the table of FIG. 5, along with the chemical structures of the components.

Thus, according to at least one embodiment, a photocurable resin system includes a resin chemistry, and 30-75% volumetric loading of UV-absorbing dark particles. In at least one embodiment, the volumetric loading may be at least 30%, in other embodiments, at least 40%, and in yet other embodiments at least 50%. In at least one embodiment, the volumetric loading is 30 to 75% of dark particles, in other embodiments, 35 to 65%, and yet other embodiments, 40%-60%. In some embodiments, the resin chemistry includes a base resin formulation and a thermal initiator compound. In certain embodiments, the base resin formulation includes a diacrylate resin, a crosslinker, a reactive diluent, and/or a photoinitiator (e.g., a diacrylate resin, a crosslinker, a reactive diluent, and a photoinitiator). According to some embodiments, the UV-absorbing particles comprise dark particles like ceramic particles, such as iron oxide, and a modified silane attached to the surface of each particle. In accordance with certain embodiments, the modified silane includes a functional arm covalently bonded with a photoinitiator. In at least one embodiment, the resin chemistry includes a diacrylate, acrylate, or methacrylate monomer resin, a crosslinker, a reactive diluent, a photoinitiator, and a thermal initiator compound. In at least one embodiment, the modified silane is IPTS, with an HMPP photoinitiator covalently bonded to the functional arm.

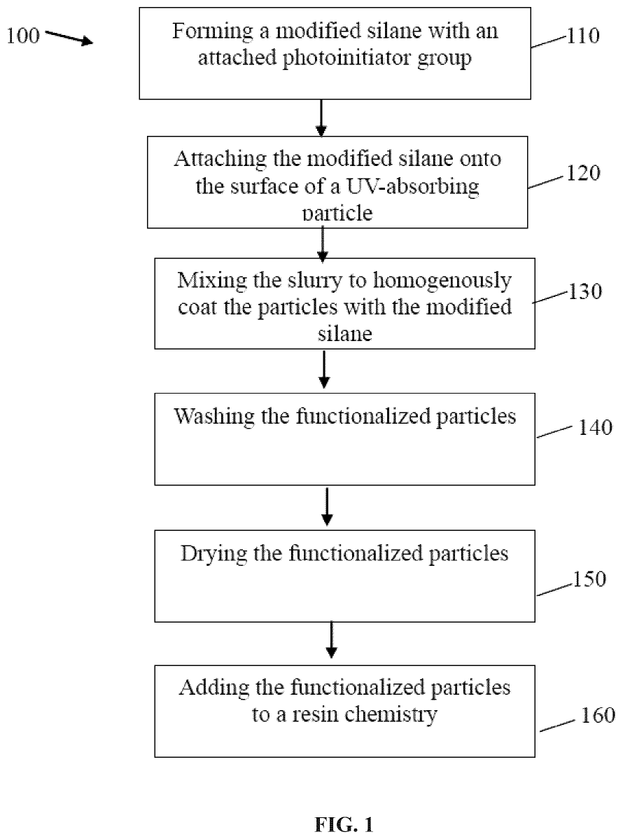

According to at least one embodiment, and with reference to FIG. 1, a method 100 of preparing a resin system with a particle with UV absorbing properties is provided. In accordance with some embodiments, method 100 includes, at step 110, forming a modified silane with a covalently attached photoinitiator group by reacting a silane such as, for example, (3-isocyanatopropyl)-triethoxysilane (IPTS) and a photoinitiator, such as 2-hydroxy-2-methylpropiophenone (HMPP), with a catalyst.

In some embodiments, the catalyst comprises a metal catalyst (e.g., a metal catalyst for cross-metathesis reactions). According to certain embodiments, the catalyst comprises a ruthenium (Ru) complex (e.g., the Grubbs catalyst, such as the Hoveyda-Grubbs catalyst with specific ligands (e.g., N-heterocyclic carbenes, iodo-anions, and/or CAACs) and which may be enhanced by one or more additives, such as CuI) and/or a molybdenum (Mo) complex (e.g., the Schrock catalyst). In accordance with some embodiments, the catalyst comprises dibutyltin dilaurate, bis(tricyclohexylphosphine)benzylidine ruthenium(II) dichloride, an N-heterocyclic carbene (NHC) ligand (e.g., [(1, 3-bis(2, 6-trimethylphenyl)-2-imidazolidinylidene)dichloro(o-isopropoxyphenylmethylene)ruthenium(II)]), a pyridine (e.g., bromopyridine), a catalyst with iodo-anions (e.g., nitro-Grela-I₂), a CAAC (cyclic alkyl(amino) carbene) ligand, 2,6-diisopropylphenylimidoneophylidene molybdenum (IV) bis(hexafluoro-t-butoxide), a catalyst from Apeiron Synthesis, a tungsten catalyst (e.g., in alkyne methathesis), an organometallic (e.g., zinc octoate, a bismuth carboxylate (e.g., bismuth neodecanoate), a titanium carboxylate, a zirconium compound, and/or potassium octoate), a bismuth catalyst (e.g., bismuth neodecanoate, a bismuth carboxylate (e.g., K-KAT 348 and/or Borchers brand)), a zinc catalyst (e.g., zinc octoate), a titanium catalyst (e.g., a titanium carboxylate), a zirconium catalyst, an organotin, iron, manganese, a metal salt (e.g., Fe, Mn) of a carboxylate, dibutyltin mercaptide, and/or a potassium salt (e.g., potassium acetate and/or potassium octoate). In some cases, use of a catalyst comprises ligand tuning (e.g., changing phosphine ligands (e.g., to NHCs) or carbene ligands). In certain embodiments, the catalyst comprises additives and/or cocatalysts, such as copper (I) iodide (CuI). In at least one non-limiting example, the catalyst may be dibutyltin dilaurate.

In some embodiments, the catalyst is provided at greater than or equal to 0.1 vol. %, greater than or equal to 0.2 vol. %, greater than or equal to 0.3 vol. %, greater than or equal to 0.4 vol. %, greater than or equal to 0.5 vol. %, greater than or equal to 0.6 vol. %, greater than or equal to 0.8 vol. %, greater than or equal to 1 vol. %, greater than or equal to 2 vol. %, greater than or equal to 3 vol. %, greater than or equal to 4 vol. %, greater than or equal to 5 vol. %, greater than or equal to 6 vol. %, or greater than or equal to 7 vol. %. In certain embodiments, the catalyst is provided at less than or equal to 10 vol. %, less than or equal to 9 vol. %, less than or equal to 8 vol. %, less than or equal to 7 vol. %, less than or equal to 6 vol. %, less than or equal to 5 vol. %, less than or equal to 4 vol. %, less than or equal to 3 vol. %, less than or equal to 2 vol. %, less than or equal to 1 vol. %, less than or equal to 0.8 vol. %, or less than or equal to 0.6 vol. %. Combinations of these ranges are also possible (e.g., greater than or equal to 0.1 vol. % and less than or equal to 10 vol. %, greater than or equal to 0.1 vol. % and less than or equal to 1 vol. %).

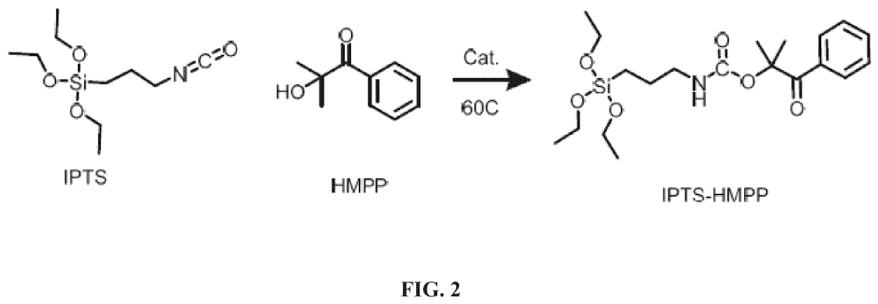

In some cases, the modified silane is formed via reaction between the isocyanate arm of the silane and the alcohol group on the photoinitiator. While silanes with isocyanate arms are described herein, this is not intended to be limiting, and silanes with varying and combinations of functional groups such as amines, methacrylate, acrylate, and epoxide groups are also suitable to initiate successful dispersion of dark particles into the resin chemistry. In some cases, the silane can be attached to the particle surface and modified with reactive groups to augment properties in bulk. Furthermore, while HMPP is provided as the photoinitiator, any suitable photoinitiator may be used to attach to the functional arm of the silane, and discussion of HMPP is not intended to be limiting. In at least one embodiment, step 110 includes the HMPP photoinitiator and the IPTS silane with the isocyanate functional arm introduced in an equal molar solution with a small percentage of dibutyltin dilaurate as the catalyst. An example process of creating the functionalized silane with an attached photoinitiator is shown in FIG. 2, in accordance with some embodiments. In the example of FIG. 2, the isocyanate arm of the silane reacts with the alcohol group on the HMPP. In certain examples, the components may be provided in any suitable vessel, such as, but not limited to, a round bottom flask. The components may be, in at least one embodiment, taken under nitrogen and stirred. In one or more embodiments, the components are mixed under heat. In some embodiments, the components are mixed at greater than or equal to 60° C., greater than or equal to 65° C., greater than or equal to 70° C., or greater than or equal to 75° C. In certain embodiments, the components are mixed at less than or equal to 80° C., less than or equal to 75° C., less than or equal to 70° C., or less than or equal to 60° C. Combinations of these ranges are also possible (e.g., greater than or equal to 60° C. and less than or equal to 80° C.). According to some embodiments, the components are mixed for greater than or equal to 1.5 hours, greater than or equal to 2 hours, greater than or equal to 2.5 hours, greater than or equal to 3 hours, greater than or equal to 3.5 hours, or greater than or equal to 4 hours. According to certain embodiments, the components are mixed for less than or equal to 4.5 hours, less than or equal to 4 hours, less than or equal to 3.5 hours, less than or equal to 3 hours, less than or equal to 2.5 hours, or less than or equal to 2 hours. Combinations of these ranges are also possible (e.g., greater than or equal to 1.5 hours and less than or equal to 4.5 hours). For example, the components may be mixed at 60-80° C. for 1.5 to 4.5 hours. In a non-limiting example, the components are mixed at 60° C. for 3 hours.

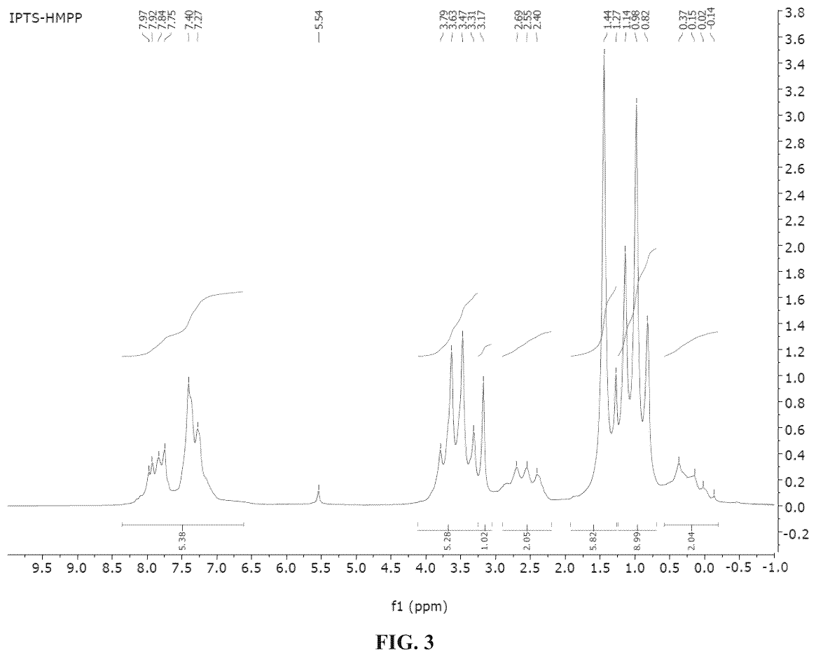

The reaction shown in FIG. 2 resulted in IPTS-HMPP, which in certain embodiments is the modified silane with a covalently attached photoinitiator group. The NMR spectrograph results of the IPTS-HMPP are shown in FIG. 3, which were consistent with the expected structure of IPTS-HMPP from the reaction. The measurement for the NMR of FIG. 3 was measured in deuterated dimethyl sulfoxide.

Referring again to FIG. 1, the method 100 further includes, at step 120, attaching the modified silane directly onto the surface of a particle to produce a slurry of functionalized dark particles, in accordance with certain embodiments. In some cases, the particle may be any suitable UV-absorbing material that provides a UV absorptive effect or property to the resin. The particle may be, in some embodiments, a dark particle such as iron oxide, but in other embodiments may be any other suitable particle or dark particle with an —OH surface group, such as, but not limited to, other ceramics with or without oxide surface groups, and reference to or discussion of dark particles, iron oxide or ceramics with oxide groups is not intended to be limiting. Thus, this method may include all dark ceramics and metal particles, as this process can be transferrable from silica to iron oxide. In certain instances, the oxide surface groups on ceramics allow for direct attachment of the modified silane to the oxide on the dark particle surface. In examples where the dark particles do not have a free oxide group on the surface (e.g., barium strontium titanate, as a non-limiting example), in some embodiments, the dark particles may be washed in a strong base in order to add oxide groups to the surface. The strong base may be any suitable strong base, such as, but not limited to, potassium hydroxide. As used herein, an oxide group is a hydroxide (—OH) group or an anionic oxygen (e.g., in a metal oxide). As used herein, an “oxide surface group” is an oxide group (e.g., a hydroxide (—OH) group or an anionic oxygen) present on a surface (e.g., of a particle). As used herein, a free oxide group is an oxide group (as defined herein) that is not involved in strong hydrogen bonding with other molecules, such that it is highly reactive.

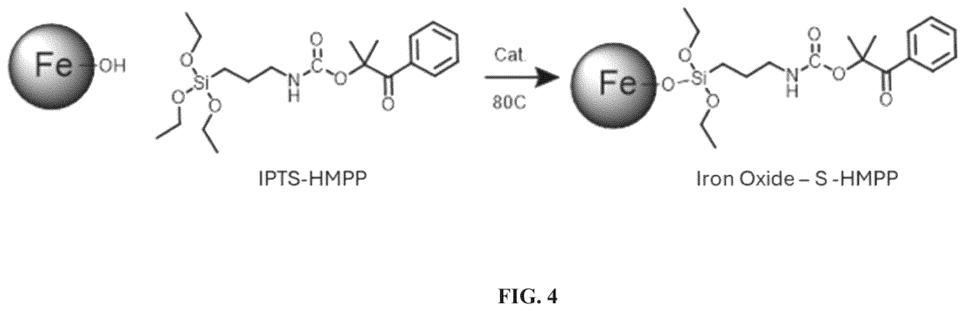

In at least one non-limiting example, the attaching of step 120 occurs by taking approximately 2.5 g of IPTS-HMPP and mixing with 1 g of dark particles. In at least one embodiment, the attaching of step 120 includes covalently bonding the silane to the surface of the dark particle. An example process of covalently attaching the silane to the surface of the dark particle is shown in FIG. 4. As shown in FIG. 4, in some instances, the dark particle with the free oxide group (—OH) is reacted with the modified silane (IPTS-HMPP). Thus, the attaching of step 120 results in the modified silane with the covalently bonded initiator attached to the surface of the dark particle, in some cases.

According to one or more embodiments, and referring again to FIG. 1, the attaching of step 120 may include attaching multiple silane groups to each particle. In certain embodiments, mixing the particles and the modified silane (e.g., the slurry of the particles and the modified silane) coats (e.g., homogeneously coats) the particles with the modified silane. In some embodiments, with vigorous mixing of the slurry at step 130, causing homogenous coating of the particles with silane, the functional arms of the silanes produce a shell around the particles, as shown schematically in FIG. 5. In some embodiments, the mixing (e.g., of the slurry) (e.g., of the particles and the modified silane) occurs at greater than or equal to 60° C., greater than or equal to 65° C., greater than or equal to 70° C., greater than or equal to 75° C., greater than or equal to 80° C., greater than or equal to 85° C., greater than or equal to 90° C., or greater than or equal to 95° C. In certain embodiments, the mixing (e.g., of the slurry) (e.g., of the particles and the modified silane) occurs at less than or equal to 100° C., less than or equal to 95° C., less than or equal to 90° C., less than or equal to 85° C., less than or equal to 80° C., less than or equal to 75° C., less than or equal to 70° C., or less than or equal to 65° C. Combinations of these ranges are also possible (e.g., greater than or equal to 60° C. and less than or equal to 100° C.). According to some embodiments, the mixing (e.g., of the slurry) (e.g., of the particles and the modified silane) occurs for greater than or equal to 5 seconds, greater than or equal to 15 seconds, greater than or equal to 30 seconds, greater than or equal to 1 minute, greater than or equal to 15 minutes, greater than or equal to 30 minutes, greater than or equal to 1 hour, greater than or equal to 2 hours, greater than or equal to 3 hours, greater than or equal to 4 hours, greater than or equal to 5 hours, greater than or equal to 6 hours, greater than or equal to 7 hours, or greater than or equal to 8 hours. According to some embodiments, the mixing (e.g., of the slurry) (e.g., of the particles and the modified silane) occurs for less than or equal to 12 hours, less than or equal to 11 hours, less than or equal to 10 hours, less than or equal to 9 hours, less than or equal to 8 hours, less than or equal to 7 hours, less than or equal to 6 hours, less than or equal to 5 hours, less than or equal to 4 hours, less than or equal to 3 hours, less than or equal to 2 hours, less than or equal to 1 hour, less than or equal to 30 minutes, less than or equal to 15 minutes, or less than or equal to 1 minute. Combinations of these ranges are also possible (e.g., greater than or equal to 5 seconds and less than or equal to 12 hours, greater than or equal to 1 hour and less than or equal to 12 hours). In at least one embodiment, the stirring occurs at 60-100° C. for 1-12 hours. In at least one non-limiting example, the stirring occurs at 80° C. for three hours. In at least one non-limiting example, the mixing of step 130 may be at 2000 RPM for 30 seconds.

In some embodiments, the functionalized particles are washed. For example, at step 140, the slurry is filtered and the functionalized dark particles are washed, in accordance with some embodiments. In at least one embodiment, the functionalized particles are washed multiple times in an alcohol rinse, such as ethanol.

After rinsing, at step 150, according to some embodiments, the functionalized particles are dried. In some embodiments, the drying (e.g., of the functionalized particles) occurs at greater than or equal to 30° C., greater than or equal to 40° C., greater than or equal to 50° C., greater than or equal to 60° C., greater than or equal to 70° C., or greater than or equal to 80° C. In certain embodiments, the drying (e.g., of the functionalized particles) occurs at less than or equal to 90° C., less than or equal to 80° C., less than or equal to 70° C., less than or equal to 60° C., less than or equal to 50° C., or less than or equal to 40° C. Combinations of these ranges are also possible (e.g., greater than or equal to 30° C. and less than or equal to 90° C. or greater than or equal to 40° C. and less than or equal to 60° C.). According to some embodiments, the drying (e.g., of the functionalized particles) occurs for greater than or equal to 6 hours, greater than or equal to 7 hours, greater than or equal to 8 hours, greater than or equal to 9 hours, greater than or equal to 10 hours, greater than or equal to 11 hours, or greater than or equal to 12 hours. According to some embodiments, the drying (e.g., of the functionalized particles) occurs for less than or equal to 18 hours, less than or equal to 17 hours, less than or equal to 16 hours, less than or equal to 15 hours, less than or equal to 14 hours, less than or equal to 13 hours, or less than or equal to 12 hours. Combinations of these ranges are also possible (e.g., greater than or equal to 6 hours and less than or equal to 18 hours, greater than or equal to 8 hours and less than or equal to 16 hours). In at least one embodiment, the drying is at 30-90° C. for 6 to 18 hours, and in another embodiment, the drying is at 40-80° C. for 8 to 16 hours. In one non-limiting example, the drying is at 60° C. for 12 hours. With reference to FIG. 1, step 110 to step 150 of method 100 may also be referring to a method of preparing a particle with UV-absorbing properties, according to at least one other embodiment.

The attaching of step 120 can be scaled appropriately based on the weight of particles provided, and the example quantities is not intended to be limiting. Thus, at step 160, in accordance with certain embodiments, the dried functionalized particles can be added directly to the resin chemistry to form a photocurable formulation with high loading of UV-absorbing particles. In at least one embodiment, the volumetric loading may be at least 30%, in other embodiments, at least 40%, and in yet other embodiments at least 50%. In at least one embodiment, the volumetric loading is 30 to 75% of dark particles, in other embodiments, 35 to 65%, and yet other embodiments, 40-60%.

According to at least one embodiment, a material system with high volumetric loading (e.g., at least 30% in some embodiments, at least 40% in other embodiments, and at least 50% in yet other embodiments) dark particles that can be suitable for light based additive manufacturing or 3D printing techniques is provided. In some cases, functionalizing dark particles with silanes that have varying functional groups provides the ability to disperse high volumetric loading of dark ceramic and metallic particles into an acrylate or methacrylate resin system. This resin system can be translated to systems that form initial printed structures with a laser that is approximately 100-1000 mW/cm² of power with a frequency range of 365-455 nm, in some embodiments. This system can further be cured thermally by the introduction of a thermal initiator into the resin in commercially available UV-Thermal Curing ovens at 80° C. for one hour, in accordance with some embodiments.

The following examples are intended to illustrate certain embodiments of the present invention, but do not exemplify the full scope of the invention.

### Example 1

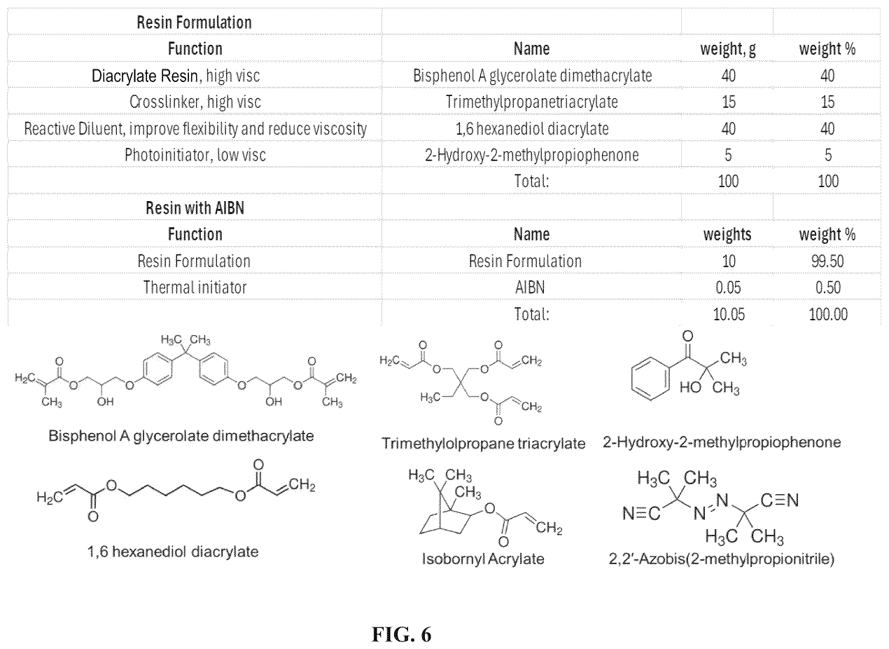

The viscosity of resins in light-based additive manufacturing may play a role in adhesion to the build plate in bottom-up photo curing systems. As the material of the bottom of the vat is cured, viscous forces may pull down on the part, allowing for separation of the part from the uncured resin. The resin chemistry described in FIG. 6 was analyzed with and without the UV-absorbing dark particles with a parallel plate rheometer (25 mm plates) to measure viscosity vs. shear rate. With both resins, as shown in FIG. 7, a relatively consistent Newtonian plateau at low shear rates was seen, with a stable viscosity of the resin chemistry of approximately 1 Pa*S and introduction of 40 vol % of particles at 11 Pa*S. As shown, the viscosity was higher for increased loading of particles. Although both resin chemistries met the requirements for SLA/DLP viscosity, which is approximately 10 Pa*s, both resins had a shear thinning behavior and the introduction of the UV-absorbing dark particles drastically increased the rate of shear in comparison to the resin chemistry without the particles loaded therein.

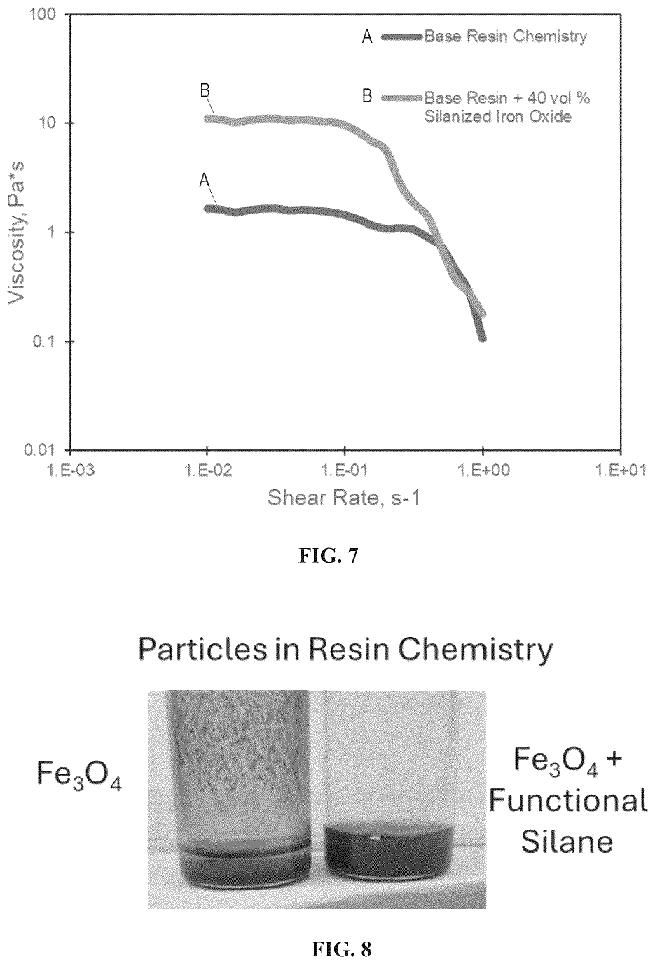

Furthermore, the homogeneity of dark particles in the resin chemistry was tested by testing the rate at which a set volume percentage of particles settled in resin after vigorous mixing (e.g., under an applied vortex or under ASTM E2690-16). As shown in the image of FIG. 8, the dark particles settled in the resin chemistry approximately 30 seconds after mixing (left vessel of FIG. 8). Dark particles modified with the functional silane IPTS-HMPP (right vessel of FIG. 8) demonstrated limited settling in solution after 1 hour post-mixing. The mitigation of particle settling with the functional silane in the resin chemistry demonstrated phase compatibility of the functional particles and the resin, which helped homogenously distribute the particles into the composite.

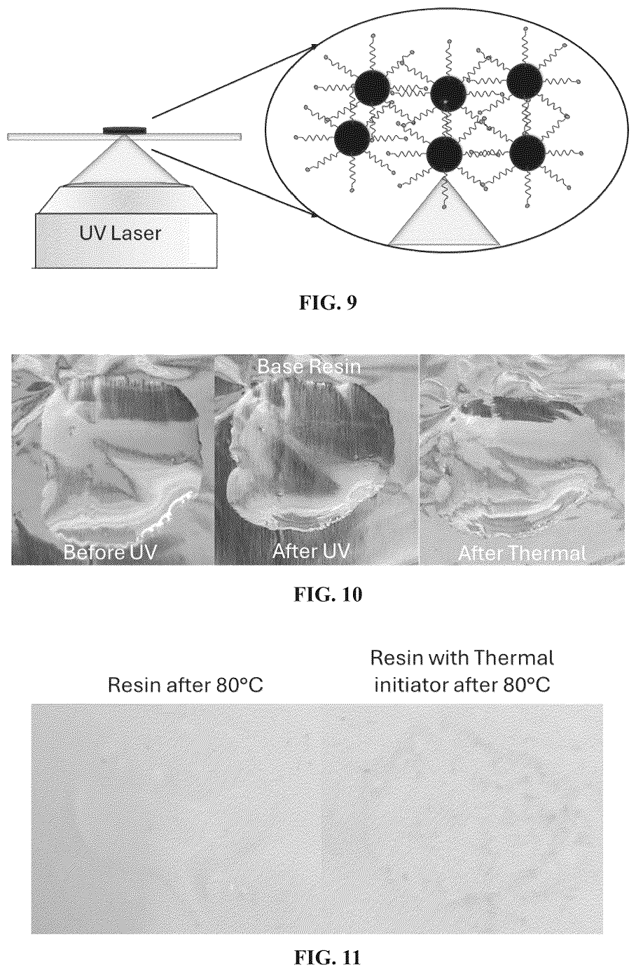

An example resin according to an embodiment of the present disclosure was photocured to mimic an SLA/DLP laser system, as schematically depicted in FIG. 9. A laser source was selected to mimic the SLA/DLP laser sources and the wavelength to identify the crosslinking process. Samples were prepared by dispensing 500 μL of material onto a glass slide and cured at 100 μm. Images were taken before and after UV curing. Samples were exposed to the UV laser for 20 seconds. Samples were then treated at 80° C. for one hour. The resin chemistry was first evaluated in this process, as shown in the image of FIG. 10. As expected, significant hardening of the resin after initial UV exposure was observed, and no resin could flow or be rubbed away. Thermal treatment showed further hardening of the resin. Although it was not a discernable change of whether the thermal initiator in the system furthered crosslinking.

To test if the thermal initiator causes the resin chemistry to free-radicalize without UV exposure, a resin chemistry without thermal initiator and with thermal initiator was created. These samples were placed in an oven at 80° C. for 2 hours. The samples without thermal initiator did not produce a solid or rigid structure, indicating that the resin chemistry did not crosslink. The resin system that included thermal initiator demonstrated a solid structure. The formation of a solid indicated that the thermal initiator was required to further crosslink the system, providing that orthogonal methods can be employed to introduce mechanical rigidity into a resin. FIG. 11 shows the samples with and without thermal initiator cured after 80° C. exposure for one hour.

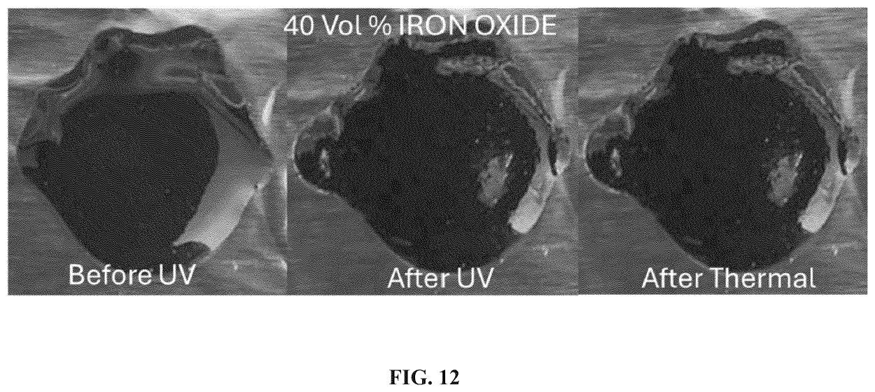

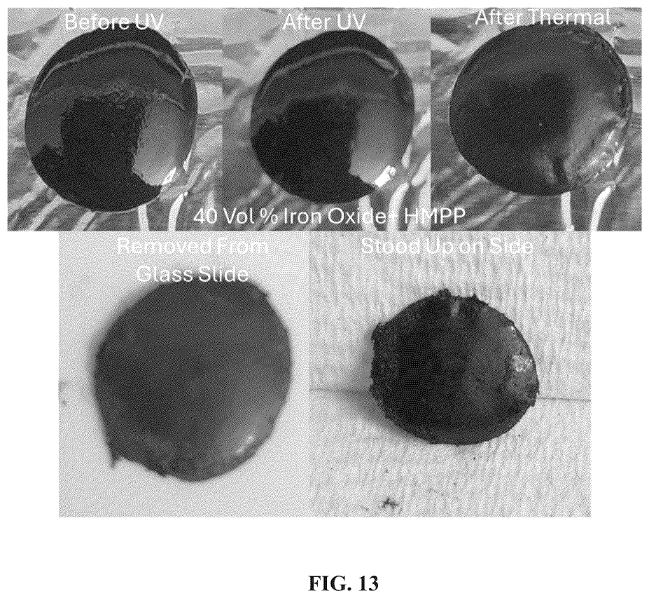

With reference to FIG. 12 and FIG. 13, images of the resin chemistry including unfunctionalized and functionalized iron oxide, respectively, were taken before and after UV treatment and after thermal treatment. Referring to FIG. 12, the 40 vol % unfunctionalized iron oxide, representing dark particles that are not modified with a silane and photoinitiator, mixed into the resin chemistry showed significant phase separation. Constant agitation was required to keep the particle dispersed into the resin to be able to pipette up the resin for dispensing. The samples were then UV cured for 20 seconds, and the lack of full curing was visually noticeable, as tilting the glass slide with sample caused the sample to deform. After thermal treatment, the sample became rigid, further indicating the success of the thermal initiator in crosslinking the resin chemistry with this structure. When trying to remove the sample from the glass slide, the sample embrittled and broke into many small pieces.

Noted with reference to FIG. 9, it was visualized that the silane functionalized particles with IPTS-HMPP would be exposed to the laser before the dark particles could absorb the laser energy, thus enabling photoinitiation and curing of the composite structure. If the photoinitiator was homogenously dispersed as in FIG. 12, the composite did not readily cure. However, as shown in FIG. 13, the samples with 40 vol % of functionalized iron oxide particles with IPTS-HMPP, according to an embodiment of the present disclosure, demonstrated suitable UV curing. Upon a 20 second exposure to the UV laser, the composite resin showed rigidity. After thermal treatment the sample further cured into a rigid composite. The sample was able to be removed from a glass slide handled without breaking. The sample was then stood up demonstrating that the composite could support itself and was fully crosslinked into a rigid resin. Thus, the curing was improved in comparison to the counterpart without the functionalized silane attached to the resin while also allowing for a higher volumetric loading of dark particles.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. As used herein, the term “about” means that the amount or value in question may be the specific value designated or some other value in its neighborhood. The term “about” or “generally” denoting a certain value is intended to denote a range within +/−5% of the value. As one example, the phrase “about 10” denotes a range of 10+/−5, i.e. the range from 95 to 105. When the term “about” or “generally” is used, it can be expected that similar results or effects according to the invention can be obtained within a range of +/−5% of the indicated value. It should also be appreciated that integer ranges (e.g., for measurements or dimensions) explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

Also, unless expressly stated to the contrary: percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

Also, unless expressly stated to the contrary: all R groups (e.g. Ri where i is an integer) include hydrogen, alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups M is a metal atom (e.g., Na, K, Li, etc.) and L- is a counter anion (e.g., Cl-, Br-, tosylate, etc.); single letters (e.g., “n” or “o”) are 1, 2, 3, 4, or 5; in the compounds disclosed herein including compounds described by formula or by name, a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups M is a metal atom (e.g., Na, K, Li, etc.) and L′ is a negative counterion; and percent, “parts of,” and ratio values are by weight.

The term “alkyl” refers to C₁₋₂₀ inclusive, linear (i.e., “straight-chain”), branched, saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

“One or more” includes a function being performed by one element, a function being performed by more than one element, e.g., in a distributed fashion, several functions being performed by one element, several functions being performed by several elements, or any combination of the above.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)} is possible, in some embodiments. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

What is claimed is:

1. A particle comprising:
a surface with a free oxide surface group thereon; and
a modified silane attached to the free oxide surface group;
wherein the modified silane comprises a functional arm attached to a photoinitiator group.

2. The particle of claim 1, wherein the particle comprises a dark ceramic particle.

3. The particle of claim 1, wherein the functional arm comprises an isocyanate, azide, alkyne, amine, methacrylate, acrylate, and/or epoxide.

4. The particle of claim 1, wherein:
the modified silane comprises 3-isocyanatopropyl)-triethoxysilane (IPTS), APTES (aminopropyltriethoxysilane), (3-mercaptopropyl)trimethoxysilane (MPTMS), glycidoxypropyltrimethoxysilane (GPTMS), vinyltrimethoxylsilane, 3-acryloxypropyl)trimethoxysilane, and/or acryloxymethyltrimethoxysilane; and/or
the photoinitiator group comprises 2-hydroxy-2-methylpropiophenone (HMPP), 1-hydroxycyclohexyl phenyl ketone (HCPK)), benzophenone, 4-methylbenzophenone, 4-chlorobenzophenone, 4,4′-bis(diethylamino)), 2-isopropylthioxanthone (ITX)), 2-ethylanthraquinone (EAQ)), diphenyl(2,4,6-trimethylbenzoyl) phosphine oxide (TPO), 2-methyl-4′-(methylthio)-2-morpholinopropiophenone (TPO-L)), and/or benzoin methyl ether (BME).

5. The particle of claim 1, wherein the particle comprises iron oxide.

6. The particle of claim 1, wherein the photoinitiator is covalently bonded to the functional arm.

7. A photocurable resin system comprising:
a resin chemistry comprising:
a diacrylate resin,
a crosslinker,
a reactive diluent, and
a photoinitiator; and
the particle of claim 1 dispersed in the resin chemistry.

8. The photocurable resin system of claim 7, wherein the resin chemistry further comprises a thermal initiator compound.

9. The photocurable resin system of claim 8, wherein the resin chemistry comprises greater than or equal to 0.1 wt % and less than or equal to 10 wt % of the thermal initiator compound.

10. The photocurable resin system of claim 7, wherein the diacrylate resin comprises a bisphenol diacrylate resin.

11. The photocurable resin system of claim 7, wherein the resin chemistry comprises:
greater than or equal to 20 wt. % and less than or equal to 70 wt. % of the diacrylate resin;
greater than or equal to 10 wt. % and less than or equal to 50 wt. % of the crosslinker;
greater than or equal to 20 wt. % and less than or equal to 60 wt. % of the reactive diluent; and
greater than or equal to 4 wt. % and less than or equal to 20 wt. % of the photoinitiator.

12. A method of forming a UV-absorbing particle, the method comprising:
forming a modified silane with an attached photoinitiator group; and
attaching the modified silane onto a surface of a particle.

13. The method of claim 12, further comprising:
mixing a slurry of the modified silane and particles to coat the particles with the modified silane and form functionalized particles.

14. The method of claim 13, further comprising:
washing the functionalized particles; and
drying the functionalized particles.

15. A method of forming a photocurable resin system, the method comprising:
forming a modified silane with an attached photoinitiator group;
attaching the modified silane onto a surface of a particle to form a functionalized particle; and
adding the functionalized particle to a resin chemistry.

16. The method of claim 15, wherein the resin chemistry comprises:
a diacrylate resin;
a crosslinker;
a reactive diluent; and
a photoinitiator.

17. The method of claim 16, wherein the resin chemistry comprises:
greater than or equal to 20 wt. % and less than or equal to 70 wt. % of the diacrylate resin;
greater than or equal to 10 wt. % and less than or equal to 50 wt. % of the crosslinker;
greater than or equal to 20 wt. % and less than or equal to 60 wt. % of the reactive diluent; and
greater than or equal to 4 wt. % and less than or equal to 20 wt. % of the photoinitiator.

18. The method of claim 15, wherein the photoinitiator group is covalently attached to a functional arm of the modified silane.

19. The method of claim 15, wherein the particle comprises a dark ceramic particle.

20. The method of claim 19, wherein:
the modified silane comprises 3-isocyanatopropyl)-triethoxysilane (IPTS), APTES (aminopropyltriethoxysilane), (3-mercaptopropyl)trimethoxysilane (MPTMS), glycidoxypropyltrimethoxysilane (GPTMS), vinyltrimethoxylsilane, 3-acryloxypropyl)trimethoxysilane, and/or acryloxymethyltrimethoxysilane; and/or
the photoinitiator group comprises 2-hydroxy-2-methylpropiophenone (HMPP), 1-hydroxycyclohexyl phenyl ketone (HCPK)), benzophenone, 4-methylbenzophenone, 4-chlorobenzophenone, 4,4′-bis(diethylamino)), 2-isopropylthioxanthone (ITX)), 2-ethylanthraquinone (EAQ)), diphenyl(2,4,6-trimethylbenzoyl) phosphine oxide (TPO), 2-methyl-4′-(methylthio)-2-morpholinopropiophenone (TPO-L)), and/or benzoin methyl ether (BME).
